(19) United States
(12) Patent Application Publication
(10) Pub. No.: US 2023/0046802 A1
(43) Pub. Date: Feb. 16, 2023

(54) INFORMATION LINKING SYSTEM, INFORMATION LINKING METHOD, AND NON-TRANSITORY COMPUTER READABLE STORAGE MEDIUM

(71) Applicant: MITANI SANGYO CO., LTD., Kanazawa-shi (JP)

(72) Inventors: Koichi MORI, Kanazawa-shi (JP); Toshiaki FUKABORI, Kanazawa-shi (JP); Tomokazu SHIGERI, Kanazawa-shi (JP); Yoshikane ODA, Kanazawa-shi (JP)

(21) Appl. No.: 17/979,086

(22) Filed: Nov. 2, 2022

Related U.S. Application Data
(63) Continuation of application No. PCT/JP2021/018382, filed on May 14, 2021.

(30) Foreign Application Priority Data
May 15, 2020 (JP) 2020-086289

(51) Int. Cl. G06F 16/25; G06F 16/2458

(52) U.S. Cl. CPC G06F 16/258; G06F 16/2462

(57) ABSTRACT

An information coordinating system includes a processor and a memory configured to store a program, the program being executed by the processor to cause the processor to acquire first system data transmitted from a first system server and second system data transmitted from the second system server, the first system data including a first identifier and a first data format associated with a first identifier, and the second system data including a second identifier, first and a second sub-data having a second data format associated with the second identifier, convert the first sub-data of the second system data to the first identifier, and convert the data format of the first and second system data to a common data format, and generate first statistical data and second statistical data by statistically processing.

### CROSS REFERENCE TO RELATED APPLICATIONS

This application is a Continuation of International Patent Application No. PCT/JP2021/018382, filed on May 14, 2021, which claims the benefit of priority to Japanese Patent Application No. 2020-086289, filed on May 15, 2020, the entire contents of which are incorporated herein by reference.

### FIELD

The present invention relates to an information linking system, an information linking method, and an information linking program.

### BACKGROUND

In the activities of companies, local governments, and financial institutions, information processing is conducted using a plurality of systems. While each system performs information processing independently, it is required to improve work efficiency by linking data between these systems. Japanese laid-open patent publication No. 2020-47144 discloses an example of an information linking system.

### SUMMARY

One embodiment of the present invention provides an information linking system including a processor and a memory device configured to store a program, the program being executed by the processor to cause the processor to: acquire first system data transmitted from a first system server and second system data transmitted from a second system server, the first system data including a first identifier and a first data format associated with a first identifier, and the second system data including a second identifier, first sub-data and second sub-data, the second identifier being different from the first identifier, and the first sub-data and the second sub-data having a second data format associated with the second identifier, convert the first sub-data of the second system data to the first identifier, and convert the first data format of the first system data and the second data format of the second system data to a common data format, and generate first statistical data by statistically processing the first system data and generate second statistical data by statistically processing the second sub-data of the second system data associated with the first identifier.

In the information linking system, the program may further cause the processor to generate analysis data by statistic processing using the first statistical data and the second statistical data when first variation data included in the second sub-data and associated with the first identifier satisfies a predetermined condition.

In the information linking system, the program may cause the processor to generate analysis data by statistic processing using the first statistical data and the second statistical data when second variation data included in the second sub-data and associated with the second identifier satisfies a predetermined condition.

In the information linking system, the first identifier may be an identifier related to a user, and the second identifier may be an identifier related to an environment.

In the information linking system, the first variation data includes a body temperature of the user, the second variation data includes a temperature of the environment, and the predetermined condition may be that the body temperature of the user or the temperature of the environment exceeds a set value.

In the information linking system, the first statistical data and the second statistical data may be numerical data, and the analysis data may be the difference between the first statistical data and the second statistical data.

In the information linking system, the program may cause the processor to compare the analysis data with a predetermined set value, and extract abnormal data deviating from the set value among the analysis data.

In the information linking system, the program may cause the processor to generate warning information to inform a user terminal of the existence of the abnormal data based on the extracted abnormal data, and transmit the warning information to the user terminal.

In the information linking system, the program may cause the processor to convert the first data format of the first system data and the second data format of the second system data into CSV format.

One embodiment of the present invention provides an information linking method including acquiring first system data transmitted from a first system server and second system data transmitted from a second system server, the first system data including a first identifier and a first data format associated with a first identifier, and the second system data including a second identifier, first sub-data and second sub-data, the second identifier being different from the first identifier, and the first sub-data and the second sub-data having a second data format associated with the second identifier, converting the first sub-data of the second system data to the first identifier, and converting the first data format of the first system data and the second data format of the second system data to a common data format, and generating first statistical data by statistically processing the first system data and generating second statistical data by statistically processing the second sub-data of the second system data associated with the first identifier.

The information linking method may further include generating analysis data by statistic processing using the first statistical data and the second statistical data when first variation data included in the second sub-data and associated with the first identifier satisfies a predetermined condition.

The information linking method may further include generating analysis data by statistic processing using the first statistical data and the second statistical data when second variation data included in the second sub-data and associated with the second identifier satisfies a predetermined condition.

In the information linking method, the first identifier may be an identifier related to a user, and the second identifier may be an identifier related to an environment.

In the information linking method, the first variation data may include a body temperature of the user, the second variation data may include a temperature of the environment, and the predetermined condition may be that the body temperature of the user and the temperature of the environment exceeds a corresponding set value.

In the information linking method, the first statistical data and the second statistical data may be numerical data, and the analysis data may be the difference between the first statistical data and the second statistical data.

In the information linking method, the information linking server may include a step of comparing the analysis data with a predetermined set value, and extracting abnormal data deviating from the set value among the analysis data.

In the information linking method, the information linking server may include a step of generating warning information to inform a user terminal of the existence of the abnormal data based on the extracted abnormal data, and transmitting the warning information to the user terminal.

In the information linking method, the program may cause the processor to convert the first data format of the first system data and the second data format of the second system data into CSV format.

One embodiment of the present invention includes a non-transitory computer readable storage medium storing a program. The program cause a computer to: acquire first system data transmitted from a first system server and second system data transmitted from a second system server, the first system data including a first identifier and a first data format associated with a first identifier, and the second system data including a second identifier the first identifier and first sub-data and second sub-data, the second identifier being different from the first identifier, and the first sub-data and the second sub-data having a second data format associated with the second identifier, convert the first sub-data of the second system data to the first identifier, and convert the first data format of the first system data and the second data format of the second system data to a common data format, generate first statistical data by statistically processing the first system data and generate second statistical data by statistically processing the second sub-data of the second system data associated with the first identifier, and generate analysis data by statistic processing using the first statistical data and the second statistical data when first variation data included in the second sub-data and associated with the first identifier satisfies a predetermined condition, wherein the first statistical data and the second statistical data are numerical data, and the analysis data is the difference between the first statistical data and the second statistical data.

By using an embodiment of the present invention, systems can be easily and quickly linked.

### BRIEF DESCRIPTION OF THE DRAWINGS

FIG. 1 is a diagram showing a configuration of hardware in an information linking system according to an embodiment of the present invention.

FIG. 2 is a functional block diagram composed of each component of an information linking system according to an embodiment of the present invention.

FIG. 3 is an example of a data structure of attendance system data.

FIG. 4 is an example of a data structure of face authentication system data.

FIG. 5 is an example of a data structure of an attendance dataset.

FIG. 6 is an example of a data structure of a work code.

FIG. 7 is an example of a data structure of comparative analysis data.

FIG. 8 is a flow diagram of an information linking method according to an embodiment of the present invention.

FIG. 9 is a flow diagram of an information linking method according to an embodiment of the present invention.

FIG. 10 is a flow diagram of an information linking method according to an embodiment of the present invention.

FIG. 11 is a flow diagram of an information linking method according to an embodiment of the present invention.

FIG. 12 is a flow diagram of an information linking method according to an embodiment of the present invention.

FIG. 13 is a diagram showing a configuration of hardware in an information linking system according to an embodiment of the present invention.

FIG. 14 is a functional block diagram composed of each component of an information linking system according to an embodiment of the present invention.

FIG. 15 is a functional block diagram composed of each component of an information linking system according to an embodiment of the present invention.

FIG. 16 is an example of a data structure of attendance system data.

FIG. 17 is an example of a data structure of face authentication system data.

FIG. 18 is an example of a data structure of attendance authentication data.

FIG. 19 is an example of a data structure of an attendance dataset.

FIG. 20 is an example of a data structure of an attendance dataset.

FIG. 21 is an example of a data structure of analysis data.

FIG. 22 is a flow diagram of an information linking method according to an embodiment of the present invention.

FIG. 23 is a flow diagram of an information linking method according to an embodiment of the present invention.

FIG. 24 is a flow diagram of an information linking method according to an embodiment of the present invention.

### DESCRIPTION OF EMBODIMENTS

Embodiments of the present invention will be described below with reference to the drawings and the like. However, the present invention can be implemented in many different modes and should not be construed as being limited to the description of the following embodiments. Although the drawings may be represented schematically for the sake of clarity of illustration, they are merely examples and do not limit the interpretation of the present invention.

The letters “first” and “second” attached to each element are convenient labels used to distinguish each element and have no further meaning unless otherwise stated. In the drawings referenced in the present embodiment, the same portions or portions having similar functions are denoted by the same or similar symbols (symbols with A, B, 1, 2, and the like added to numerals xxx), and a repetitive description thereof may be omitted. Part of the configuration may be omitted from the drawings. In addition, if it can be recognized by a person ordinarily skilled in the art to which the present invention belongs, no particular explanation will be given.

Linking conventional systems requires the development of a dedicated program, which is costly and time-consuming.

In view of such problems, one of the objects in the present invention is to link systems easily and quickly.

### First Embodiment

An information linking system and an information linking method according to the first embodiment of the present invention will be described in detail with reference to the drawings.

### (1-1. Hardware Configuration of Information Linking System)

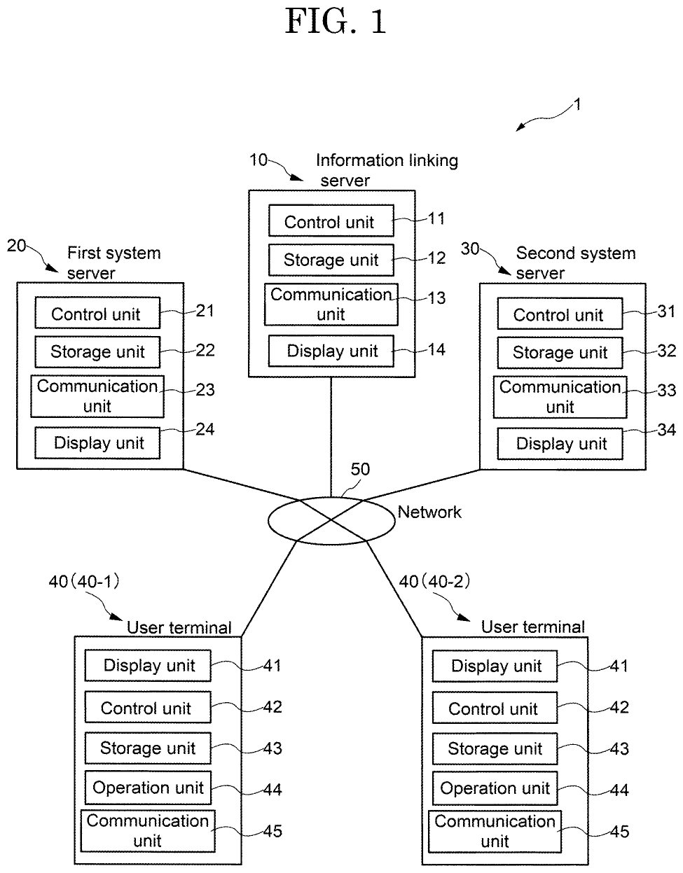

FIG. 1 shows a hardware configuration of an information linking system 1. In a part of the configuration of the information linking system 1, information linkage processing for linking the systems easily and quickly is executed. As shown in FIG. 1, the information linking system 1 includes an information linking server 10, a first system server 20, a second system server 30, and a user terminal 40. The information linking server 10 functions as an application server that acquires first system data input from a first system (also referred to as a first application) functioning in the first system server 20 and second system data input from a second system (also referred to as a second application) functioning in the second system server 30, converts the first system data and the second system data as a common data format and stores in a database for information linkage (also referred to as a web database), and transmits and receives to and from a user terminal 40-1 and a user terminal 40-2.

The first system server 20 includes various systems together with the first system. In this example, the first system server 20 is provided as a cloud server. In the first system server 20, various core business systems are executed on a serverless architecture called a FaaS (Function as a Service). In the present embodiment, an attendance management system is used as an example of the FaaS serving as the first system. The second system server 30 includes various systems together with the second system. In this example, the second system server 30 is provided as a cloud server. In this example, various information systems are executed as the FaaS in the second system server 30. More specifically, in the present embodiment, a face authentication system is used as an example of the FaaS. The information linking server 10, the first system server 20, and the second system server 30 are composed of a plurality of information processing devices.

The user terminal 40 is a terminal that inputs information to each system and transmits and receives various information. In FIG. 1, although two user terminals 40 are provided (user terminal 40-1, user terminal 40-2), one, or three or more may be provided. In the following description, for the sake of explanation, the user terminal 40 will be described except for special cases. A configuration of each hardware in the present embodiment is shown below.

The information linking server 10 includes a control unit 11, a storage unit 12, a communication unit 13, and a display unit 14. The control unit 11, the storage unit 12, the communication unit 13, and the display unit 14 are connected via a bus. In the present embodiment, the information linking server 10 is composed of a plurality of information processing devices and is provided as a cloud server.

The control unit 11 is a computer and controls processing based on instructions defined in software (program) for executing information linkage processing using a CPU (Central Processing Unit), an ASIC (Application Specific Integrated Circuit), an FPGA (Field Programmable Gate Array), or other calculation processing circuits. Instructions from the control unit 11 may provide the display unit 14 with a user interface for executing an information linking program.

In addition to an SSD (Solid State Drive) semiconductor memory and the like, a magnetic recording medium (magnetic tape, magnetic disk, and the like), an optical recording medium, a magneto-optical recording medium, and other storage-capable elements are used as the storage unit 12. The storage unit 12 stores an information linking program and functions as an information linkage information database for storing the first system data and the second system data used in the information linking program. The storage unit 12 may be provided on a server different from the information linking server 10 as appropriate and may function as a database.

The communication unit 13 is connected to a network 50 based on the control of the control unit 11 and performs transmission and reception of data between external devices. The communication unit 13 includes, for example, a modem or an NIC (Network Interface Card). The communication between the communication unit 13 and the first system server 20, the second system server 30, and the user terminal 40 is performed using the Internet (specifically, SSL (Secure Sockets Layer)/TLS (Transport Layer Security) or VPN (Virtual Private Network)) or an intranet.

The first system server 20 includes a control unit 21, a storage unit 22, a communication unit 23, and a display unit 24. The control unit 21, the storage unit 22, the communication unit 23, and the display unit 24 are connected via a bus. In the present embodiment, the first system server 20 is composed of a plurality of information processing devices and is provided as a cloud server.

The control unit 21 is a computer and uses a CPU, an ASIC, an FPGA, or other calculation processing circuits to control processing based on instructions defined in software (program) for executing each system. Instructions from the control unit 21 may provide the display unit 24 with a user interface for executing an information linking program.

In addition to the semiconductor memory or the like of the SSD, a magnetic recording medium, an optical recording medium, a magneto-optical recording medium, and other storage-capable elements are used as the storage unit 22. The storage unit 22 stores a program related to the information linking program and has a function as an information linkage information database for storing data (e.g., first system data) used in the program of the first system. The storage unit 22 may be provided on a server different from the first system server 20 as appropriate and may function as a database.

The communication unit 23 includes a transmitter and a receiver for performing communication between the information linking server 10, the second system server 30, the user terminal 40, and transmitting other related information via the network 50. The communication unit 23 may include, for example, a modem or NIC. The communication between the communication unit 23 and the information linking server 10, the second system server 30, and the user terminal 40 is performed using the Internet (specifically, SSL/TLS or VPN) or an intranet.

The second system server 30 includes a control unit 31, a storage unit 32, a communication unit 33, and a display unit 34. The control unit 31, the storage unit 32, the communication unit 33, and the display unit 34 are connected via a bus. In the present embodiment, the second system server 30 is composed of a plurality of information processing devices and is provided as a cloud server. The configuration of the second system server 30 is the same as that of the first system server 20, and therefore will not be described.

The user terminal 40 includes a display unit 41, a control unit 42, a storage unit 43, an operation unit 44, and a communication unit 45. The display unit 41, the control unit 42, the storage unit 43, the operation unit 44, and the communication unit 45 are connected via a bus. The user terminal 40 may be a smartphone, a cellular phone (feature phone), a tablet-type terminal, a notebook PC (Personal Computer), a desktop PC, an IoT (Internet of Things) device (for example, a device having a power source, a control function, a communication function, and an information storage function), and the like, and can be applied to any device capable of communicating with the information linking server 10 through a network.

The display unit 41 is a display device such as a liquid crystal display or an organic EL (Electro Luminescence) display, and content which is displayed is controlled by a signal input from the control unit 42.

The control unit 42 is a computer and includes a CPU, an ASIC, an FPGA, or other calculation processing circuits. The control unit 42 executes programs stored in the storage unit 43, such as memory, based on the operations of the display unit 41 and the operation unit 44. The control unit 42 transmits information for instructing execution of processing related to the information linking program stored in the storage unit 12 of the information linking server 10.

The operation unit 44 includes a controller, a button, or a switch. When the user performs an operation, such as moving up, down, left, or right, pressing, or rotating using the operation unit 44, information based on the operation is input into the control unit 42. If it is a display device (touch panel) having a touch sensor, the display unit 41 and the operation unit 44 may be arranged in the same location.

The communication unit 45 has a function of performing transmission and reception of data between the information linking server 10. For example, a transceiver via a LAN is used for the communication unit 45. The communication unit 45 is not limited to the transceiver via a LAN and may be provided with a transceiver for a portable terminal communication (e.g., LTE communication), or may be provided with a transceiver for near field communication. The user terminal 40 is connected to the information linking server 10 via the network 50.

### (1-2. Configuration of Information Linkage Control Unit 100)

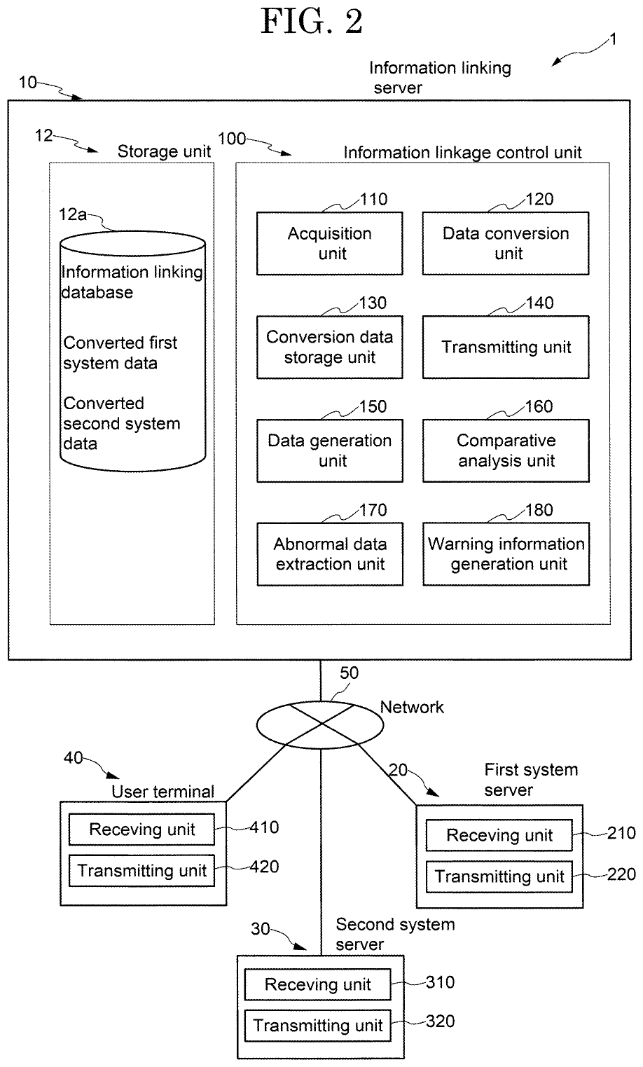

FIG. 2 is a functional block diagram composed of each component of the information linking system 1.

The information linking server 10 includes an information linkage control unit 100 that controls a program (information linking program) for realizing the information linkage function. The information linkage control unit 100 includes an acquisition unit 110, a data conversion unit 120, a conversion data storage unit 130, a transmitting unit 140, a data generation unit 150, a comparative analysis unit 160, an abnormal data extraction unit 170, and a warning information generation unit 180. Each of the acquisition unit 110, the data conversion unit 120, the conversion data storage unit 130, the transmitting unit 140, the data generation unit 150, the comparative analysis unit 160, the abnormal data extraction unit 170, and the warning information generation unit 180 in the information linking server 10 may be executed as a FaaS.

The acquisition unit 110 has a function of acquiring various data in the information linking system. For example, the acquisition unit 110 may have a function of acquiring the first system data processed in the first system, which is one FaaS in the first system server 20, and the second system data processed in the second system, which is one FaaS in the second system server 30. The acquisition unit 110 in this case may be referred to as a first acquisition unit.

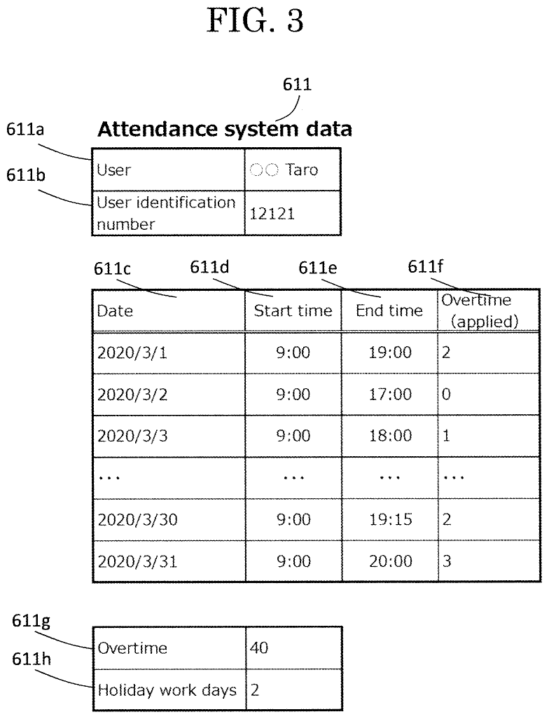

FIG. 3 is an example of a data structure of the first system data. In this example, attendance data 611 in an attendance system is shown as the first system data. The attendance data 611 includes a username 611a, a user identification number 611b, a date 611c, a start time 611d, an end time 611e, an overtime 611f, and holiday work days 611g. The start time 611d indicates the start time registered by the user. The end time 611e indicates the end time registered by the user. The overtime 611f indicates the overtime calculated based on the start time and the end time. The holiday work days 611g indicates the number of holiday work days registered by the user.

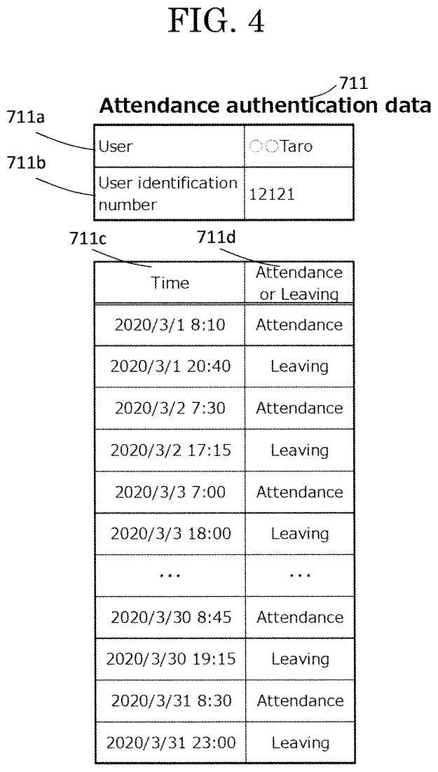

FIG. 4 is an example of a data structure of the second system data. In this example, attendance authentication data 711 in the face authentication system is shown as the second system data. The attendance authentication data 711 includes a username 711a, a user identification number 711b, a time 711c, and an attendance 711d. In the face authentication system, the attendance time and the leaving time of the user are authenticated by using the time 711c and the attendance 711d.

The acquisition unit 110 may have a function of acquiring data corresponding to the first system data or the second system data transmitted from the user terminal 40. The acquisition unit 110 in this case may be referred to as a second acquisition unit.

The data conversion unit 120 has a function of converting the first system data and the second system data into a common data format. In this example, the data conversion unit 120 converts the first system data and the second system data into CSV format.

The conversion data storage unit 130 has a function of storing the converted first system data and second system data in a database. In this example, the converted first system data and second system data are converted into an information linking database (also referred to as a web database) in the storage unit 12.

The transmitting unit 140 has a function of transmitting the converted first system data and second system data to the user terminal 40-1 and the user terminal 40-2. In this example, the converted first system data and second system data are transmitted as display data.

The data generation unit 150 associates the first system data and the second system data with each identifier to generate a dataset corresponding to the identifier. In this case, the data generation unit 150 associates the attendance data of the face authentication system and the attendance data of the attendance system with the identification number of the user and generates a dataset (attendance dataset) corresponding to the identification number of a specific user. The dataset may be generated before the converted data is stored in the information linking database.

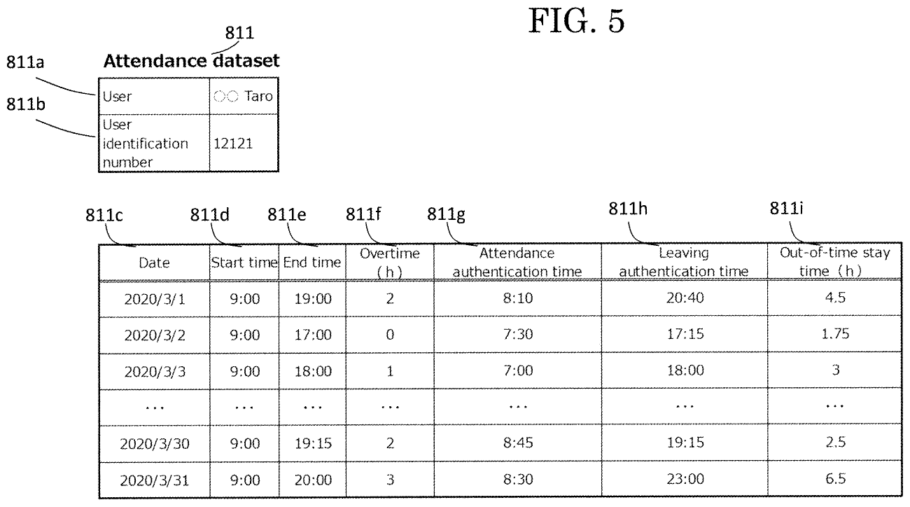

FIG. 5 is an example of a data structure of an attendance dataset 811. The attendance dataset 811 includes a username 811a, a user identification number 811b, a date 811c, a start time 811d, an end time 811e, an applied overtime time 811f, an attendance authentication time 811g, a leaving authentication time 811h, and an out-of-time stay time 811i. In this example, the attendance system data and the face authentication system data are associated with the user's identifier. Thus, an attendance dataset of a user having an identification number 12121 dataset is generated. The start time 811d, the end time 811e, and the applied overtime 811f are data processed by the attendance system. The attendance authentication time 811g, the leaving authentication time 811h, and the out-of-time stay time 811i are data processed by the face authentication system. The out-of-time stay time 811i is calculated from the attendance authentication time 811g and the leaving authentication time 811h.

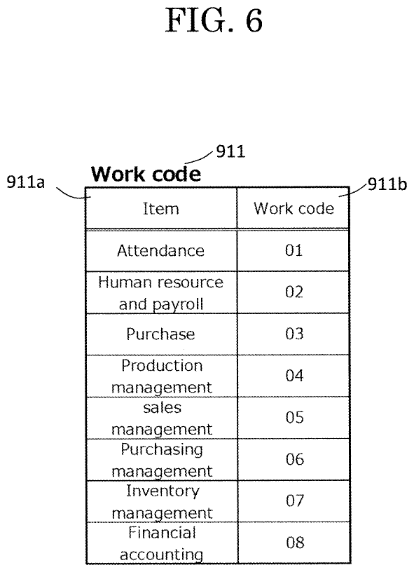

The first system data and the second system data may be associated with each other by an identifier of the work unit. FIG. 6 is an example of a data structure of a work code. A work code 911 includes a work item 911a and a code 911b. In the present embodiment, the attendance item (work code 01) is assigned to each of the attendance system data and the face authentication system data. Thus, a more detailed dataset can be generated by combining the attendance system data and the authentication system data with the work code 01 (attendance) and using the identification number of the user.

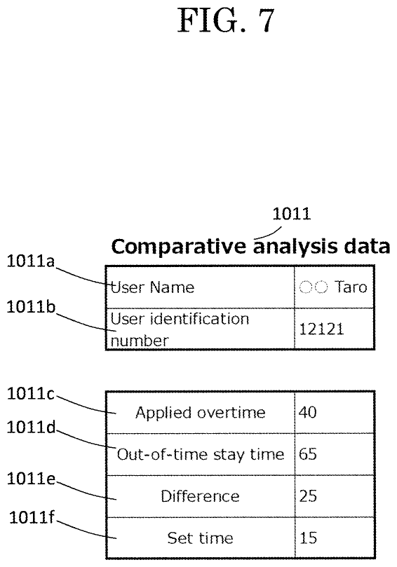

The comparative analysis unit 160 has a function of comparing and analyzing the generated dataset and a set value set in a predetermined condition. FIG. 7 is an example of a data structure of comparative analysis data 1011. The comparative analysis data 1011 includes a username 1011a, a user identification number 1011b, an applied overtime 1011c, an out-of-time stay time 1011d, a difference 1011e obtained by subtracting the overtime from the out-of-time stay time, and a set time 1011f.

The abnormal data extraction unit 170 has a function of extracting abnormal data deviating from the set value from the comparatively analyzed dataset.

The warning information generation unit 180 has a function of generating warning information for notifying the presence of the abnormal data to the user terminal 40 based on the abnormal data. The warning information may be display data such as character data or image data, or music data.

The first system server 20 executes the processing defined in a program related to an information linkage processing program stored in the storage unit 22. The first system server 20 has a receiving unit 210 and a transmitting unit 220 as functional units. The receiving unit 210 has a function of receiving various data from the information linking server 10 and the user terminal 40. The transmitting unit 220 has a function of transmitting various information linkage information including the first system data to the information linking server 10.

The second system server 30 executes the processing defined in a program related to the information linkage processing program stored in the storage unit 32. The second system server 30 has a receiving unit 310 and a transmitting unit 320 as functional units. The receiving unit 310 has a function of receiving various data from the information linking server 10 and the user terminal 40. The transmitting unit 320 has a function of transmitting various information linkage information including the second system data to the information linking server 10.

The user terminal 40 executes the processing defined in a program related to the information linkage processing program stored in the storage unit 43. The user terminal 40 has a receiving unit 410 and a transmitting unit 420 as functional units. The receiving unit 410 has a function of receiving the first system data and the second system data converted from the information linking server 10. The transmitting unit 420 has a function of transmitting a part of the converted first system data and second system to the information linking server 10.

### (1-3. Information Linkage Control Processing)

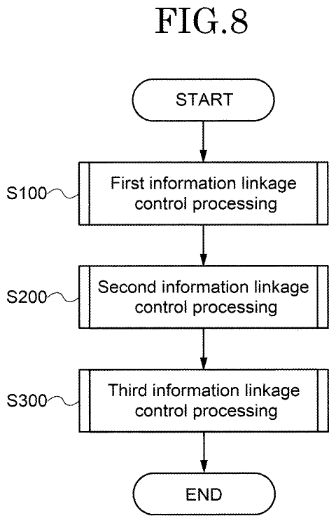

Next, information linkage control processing based on instructions by the information linking program in the information linkage control unit 100 will be described. FIG. 8 is a flow diagram of information linkage control processing. As shown in FIG. 8, the information linkage control processing includes first information linkage control processing S100, second information linkage control processing S200, and third information linkage control processing S300.

The first information linkage control processing S100 includes first system data generation processing and second system data generation processing. The second information linkage control processing S200 includes system data acquisition processing, system data conversion processing, and converted data storage processing. The third information linkage control processing S300 includes data display processing, comparative analysis processing, and abnormal data extraction processing. Each information linkage control processing is described separately.

### (1-3-1. First Information Linkage Control Processing)

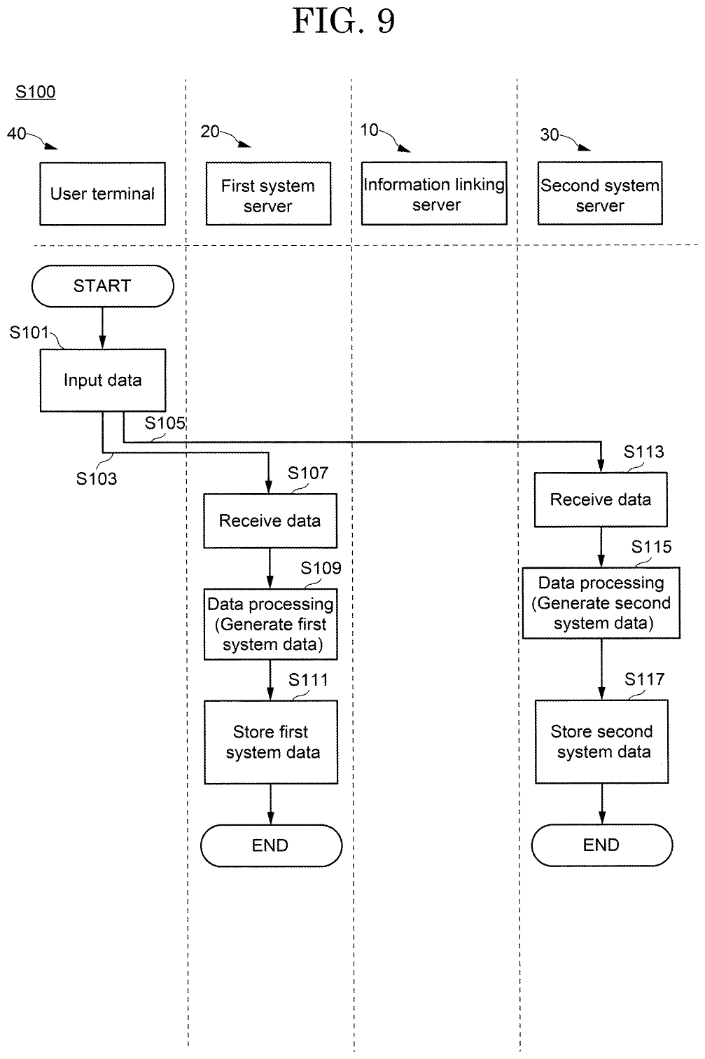

As shown in FIG. 9, data is first input to the first system (attendance management system) and the second system (face authentication system) in the user terminal 40 (S101). More specifically, a user of the user terminal 40-1 (for example, a field supervisor of the main contractor or an employee of a management department of a cooperating company) of the user terminal 40-1 inputs data (attendance work data) to the first system, and a user (for example, a field worker) of the user terminal 40-2 inputs data (attendance authentication data) to the second system. Each input data is transmitted to the first system server and the second system server (S103, S105).

When the first system server 20 receives the data input by the user terminal 40-1 (S107), the first system server 20 executes data processing (S109). Thus, the first system data is generated. The generated first system data is stored in the storage unit 22 of the first system server 20 (S111). In this example, attendance system data is generated as shown in FIG. 3. More specifically, in the attendance system, the start time 611d and the end time 611e of the user are registered by an input to the user terminal 40 from the user registered in the attendance system. Further, the overtime 611f is calculated based on the registered start time 611d and the end time 611e. The data processing may be repeatedly executed a plurality of times. As a result, a plurality of system data conforming to the standard of the first system can be memorized and stored.

When the second system server 30 receives the data input by the user terminal 40-2 (S113), the second system server 30 executes data processing (S115). Thus, the second system data is generated. The generated second system data is stored in the storage unit 32 of the second system server 30 (S117). In this example, the attendance authentication system data is generated, as shown in FIG. 4. Specifically, when the user holds their face over the user terminal 40 in the face authentication system, the face data of the user is input (captured) by a solid-state image sensor (for example, a CMOS sensor) mounted on the user terminal 40. In this case, the input data is associated with the registered user's face data, and the user is recognized (identified). As a result, the attendance time and the leaving time of the user are authenticated and registered using the time 711c and the attendance 711d shown in FIG. 4. The data processing may be repeatedly executed a plurality of times. As a result, a plurality of second system data conforming to the standard of the second system can be memorized and stored. As a result, the first information linkage control processing is completed.

### (1-3-2. Second Information Linkage Control Processing)

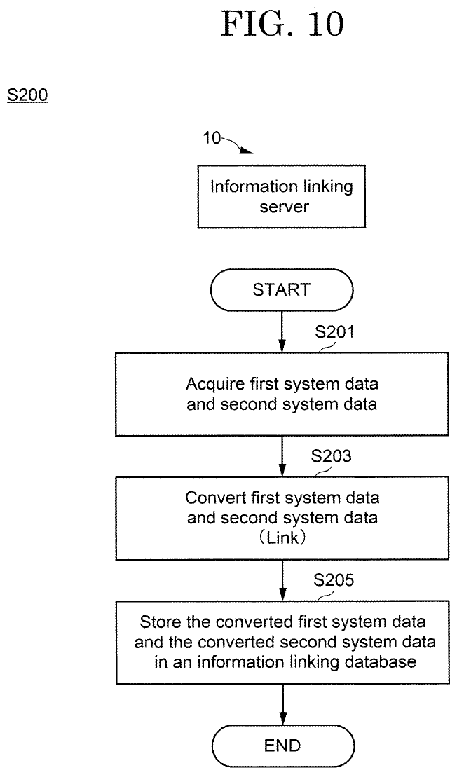

The second information linkage control processing starts with the completion of the first information linkage control processing as a trigger. As shown in FIG. 10, the acquisition unit 110 of the information linking server 10 acquires the first system data from the first system server 20 and then acquires the second system data from the second system server 30 (S201). In this example, the transmitting unit 220 of the first system server 20 transmits the generated first system data to the information linking server 10 after a lapse of a predetermined time. Thereby, the acquisition unit 110 receives the generated first system data. Similarly, the transmitting unit 320 of the second system server 30 transmits the generated second system data to the information linking server 10 after a lapse of a predetermined time. Thereby, the acquisition unit 110 receives the generated second system data.

Next, the data conversion unit 120 converts the acquired first system data and the second system data into a common data format (S203). In this example, the data conversion unit 120 converts the first system data and the second system data into CSV format.

Next, the conversion data storage unit 130 stores the converted first system data and the second system data in an information linking database 12a (web database) (S205). As a result, the system data of the two standards (formats) can be stored in one system (also called a common system) as one standard. As a result, the second information linkage control processing is completed.

### (1-3-3. Third Information Linkage Control Processing)

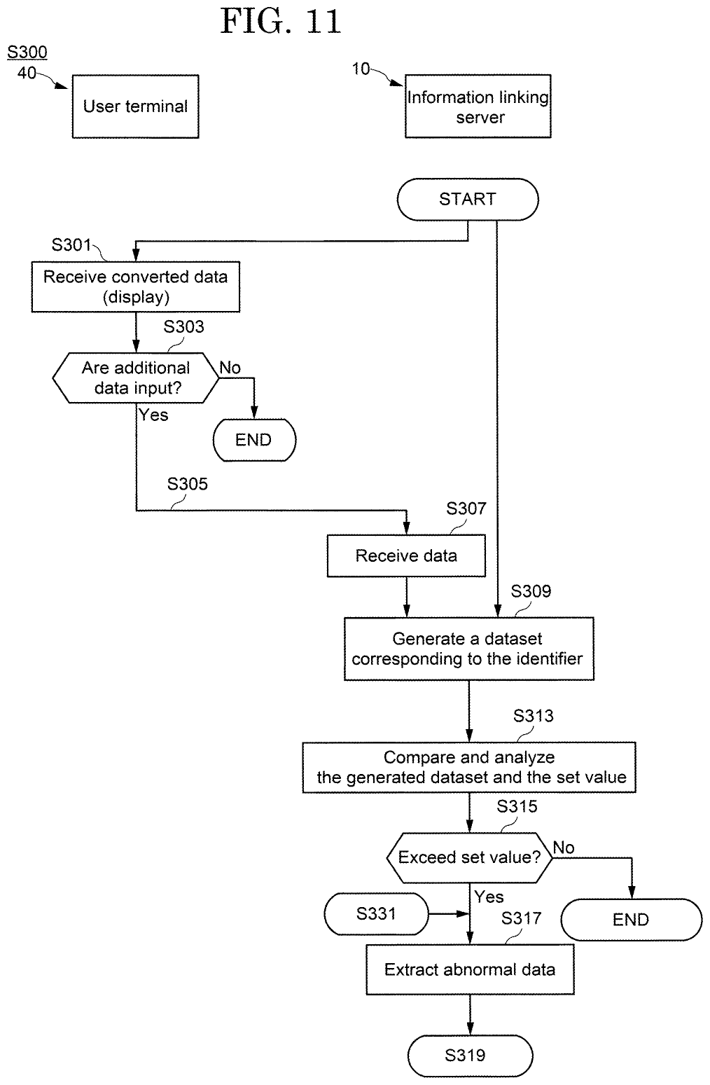

The third information linkage control processing starts with the completion of the second information linkage control processing as a trigger. First, as shown in FIG. 11, the transmitting unit 140 transmits the converted first system data and second system data (also referred to as information linking data) to the user terminal 40 (S301). In this case, the information linkage data is preferably transmitted as data that can be displayed on the user terminal 40. Thus, the display unit 41 of the user terminal 40 can display data of the two systems as one system (also referred to as a common system) once via the user interface. For example, the user (the field supervisor of the main contractor) of the user terminal 40-1 can confirm whether there are any remaining workers in the field at the end time of the work by confirming the information linking data in the common system displayed on the user terminal 40-1.

In the case where additional data (also referred to as third system data) corresponding to the information linking data is input with respect to the information linking data via the user interface displayed on the display unit 41 (S303; Yes), the transmitting unit 420 of the user terminal 40 may transmit additional data to the information linking server 10 (S305). Specifically, the user (the field worker) of the user terminal 40-2 may input attendance application data via the user interface of the common system. Alternatively, the user of the user terminal 40-1 (the employee of the management department of the cooperating company) may input various data such as input of aggregated data related to the dispatch status of workers via the user interface of the common system. The information linking server 10 receives the additional data transmitted from the user terminal 40 (S307).

Next, the data generation unit 150 associates the information linking data with each identifier to generate a dataset corresponding to the identifier (S309). In this example, an attendance dataset using the user identification number as an identifier is generated, as shown in FIG. 5.

Next, the comparative analysis unit 160 compares and analyzes the generated dataset and the set value which is set to a predetermined condition (S313). More specifically, a difference between the overtime of the user and the actual out-of-time stay time based on the information of the attendance authorization time, as shown in FIG. 7. In this case, a set time of 15 hours or less is set as a predetermined condition. In the case where the difference exceeds (deviates from) the set time (S315; Yes), the data is judged as abnormal data. In FIG. 7, it is determined that the user's March 2020 attendance data is abnormal data since the difference exceeds the set value. The abnormal data extraction unit 170 extracts abnormal data (S317).

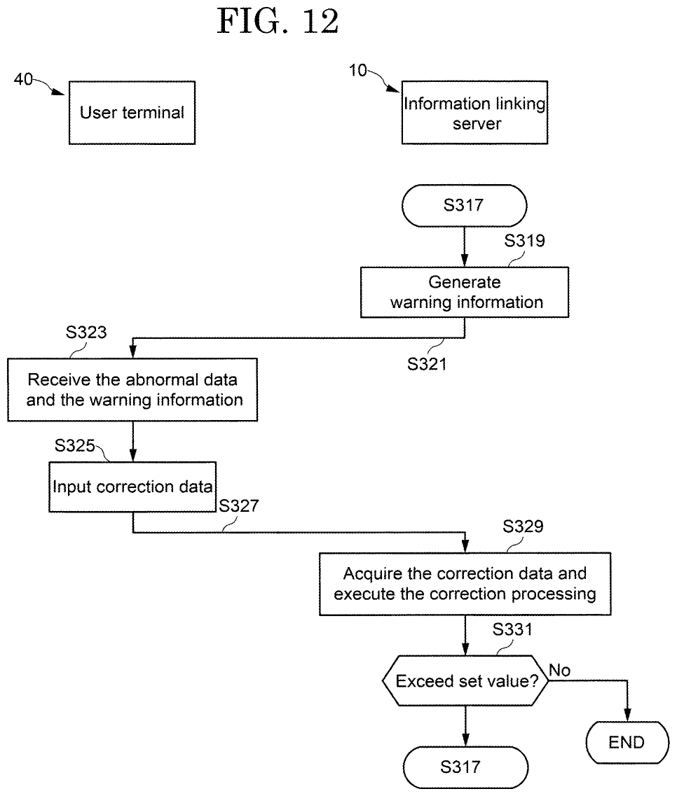

Next, as shown in FIG. 12, the warning information generation unit 180 generates warning information for notifying the user terminal 40 of the presence of the abnormal data based on the abnormal data (S319). The warning information may be display data such as character data or image data, music data, or light data (blinking of light). The transmitting unit 140 transmits abnormal data and warning data to the user terminal 40 (S321). When the user terminal 40 receives the abnormal data and the warning information (alert) (S323), the user can know the presence of abnormal data.

In this case, correction data for abnormal data may be input to the user terminal 40 (S325). When the correction data is transmitted to the information linking server 10 (S327), the acquisition unit 110 of the information linking server 10 acquires the correction data and may execute correction processing of the dataset (S329). In this case, the comparative analysis unit 160 may compare and analyze the modified dataset and the set value set to the predetermined condition (S331). If it exceeds the set value (S333; Yes), the process may return to the abnormal data extraction process (S317) again. As a result, the third information linkage control processing is completed.

As described above, systems can be easily and quickly linked by using the present embodiment. As a result, the attendance information of the user can be grasped in detail, and appropriate and efficient attendance management can be performed.

### Second Embodiment

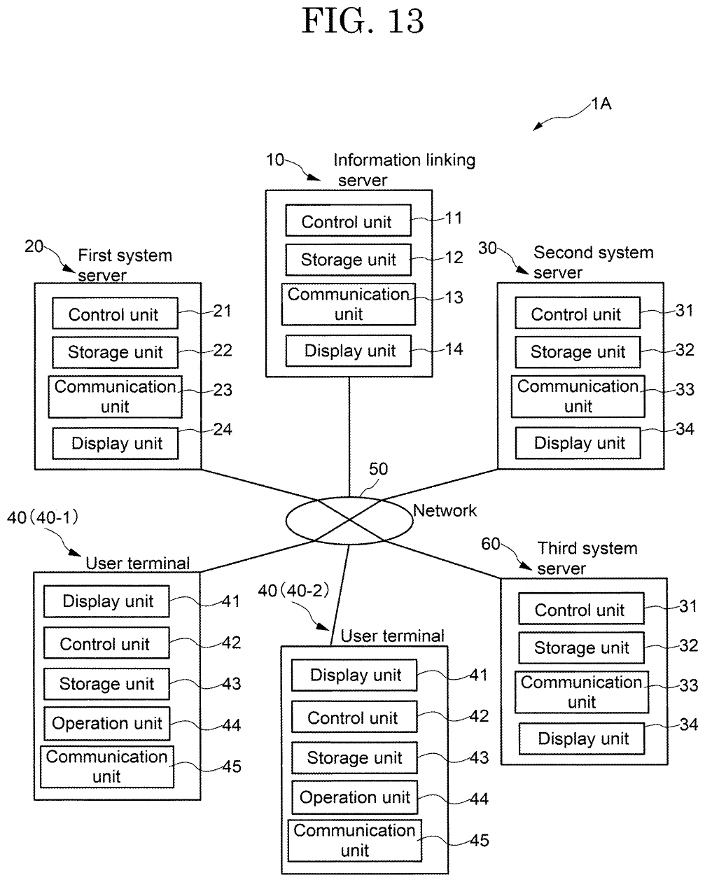

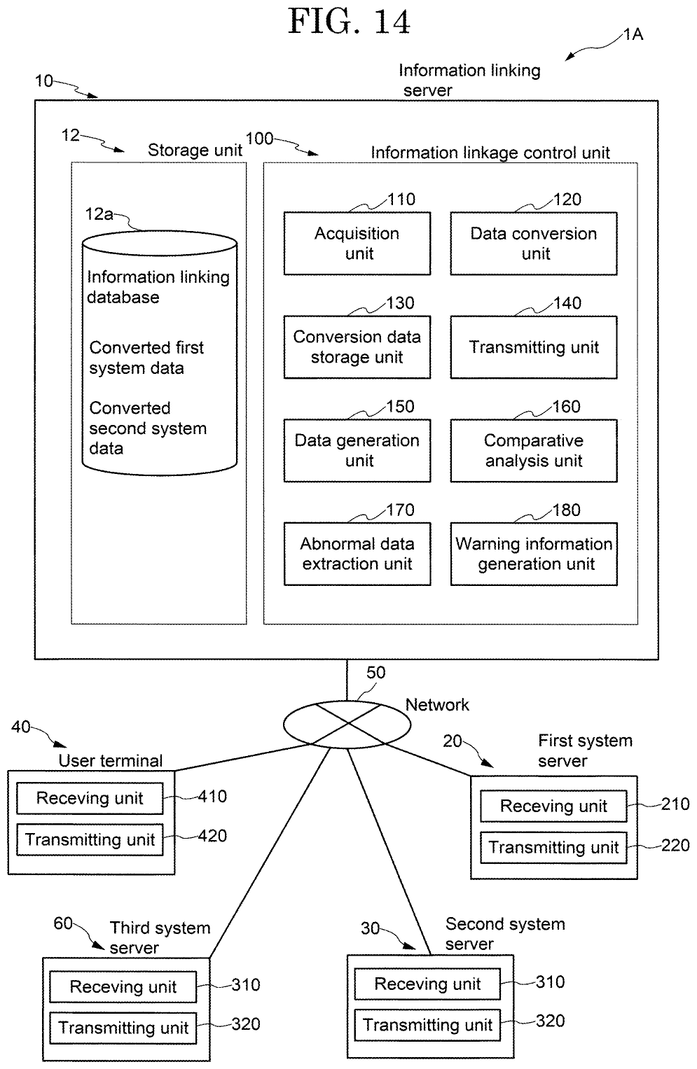

In the first embodiment of the present invention, although an example in which the systems provided in two system servers are linked is shown, the present invention is not limited thereto. In the present embodiment, an example of linking systems provided in three or more system servers will be described. FIG. 13 is a hardware configuration diagram of an information linking system 1A. FIG. 14 is a functional block diagram composed of each component of the information linking system 1A. The information linking system 1A includes a third system server 60 in addition to the information linking server 10, the first system server 20, the second system server 30, and the user terminal 40.

The third system server 60 includes a control unit 61, a storage unit 62, a communication unit 63, and a display unit 64. The control unit 61, the storage unit 62, the communication unit 63, and the display unit 64 are connected via a bus. In the present embodiment, the third system server 60 is composed of a plurality of information processing devices and is provided as a cloud server. The configuration of the third system server 60 is the same as that of the first system server 20, and therefore will not be described.

The third system server 60 includes various systems together with the third system. Various systems are executed on the FaaS in the third system server 60. In the present embodiment, a production management system is used as the first system, a sales support system is used as the second system, and a data analysis system is used as the third system.

In the present embodiment, when production data is input to the first system (production management system) of the first system server 20 via the user interface displayed on the user terminal 40-1 by the user of the user terminal 40-1 (for example, a person in charge of the production department), the user terminal 40-1 transmits the data to the first system server 20. The first system server 20 generates first system data (e.g., production management data relating to production plans and production performance). The user of the user terminal 40-2 (for example, a person in charge of the head office sales department) inputs negotiation data to the second system (sales support system) of the second system server 30 via the user interface displayed on the user terminal 40-2, and the user terminal 40-2 transmits the data to the second system server 30. The second system server 30 generates second system data (e.g., sales support data such as negotiation progress).

In the present embodiment, by converting the acquired first system data (production management data) and second system data (sales support data) into a common data format, the information linking data in which two system data are linked can be generated. As a result, it is possible to display various data as one system (common system). Therefore, the person in charge of the production department acquires the activity information of the sales department, and the person in charge of the sales department can easily grasp the inventory situation, and it is possible to promote the sales activity.

In the present embodiment, the information linking data may be associated with each identifier to generate a dataset corresponding to the identifier. In this example, a negotiation number is used as an identifier to generate a dataset corresponding to each negotiation number. As a result, the person in charge of the production department and the person in charge of the sales department can easily grasp the production volume data and the gross profit margin data for each case. Further, the dataset corresponding to each negotiation number and set value set in the predetermined condition may be compared and analyzed. For example, the profit margin may be set. In this case, the information linking server 10 may extract a low margin case as abnormal data, generate warning information (alert data), and transmit the warning information to the user terminal 40. As a result, the person in charge of the sales department and the person in charge of the production department can know cases where there is a low margin and can adjust the production volume for the product of these cases.

In the present embodiment, the analysis processing may be newly performed on the information linking data in which two system data are linked by using the analysis system. As a result, while the first system data and the second system data have conventionally had to be separated from each other and the analysis processing has to be executed, the data of the common system can be analyzed in detail as a whole.

In this embodiment, analysis processing by deep learning using machine learning processing or Artificial Intelligence (AI) in the analysis system may be performed to each dataset. As a result, it is possible to calculate the demand forecast data of the products for each project, and generate and transmit warning information for adjusting the production volume of the product expected to deviate significantly from the set value, and the person in charge in the production department can adjust the production volume from the warning information transmitted to the user terminal 40.

In the present embodiment, although an example in which the information linking system 1A uses the production management system as the first system, the sales support system as the second system, and the data analysis system as the third system is shown, the present invention is not limited thereto. The information linking system can also be used in financial related systems.

Specifically, a budget control system for supporting a company that starts up in business may be used as the first system, a sales support system may be used as the second system, and an accounting system may be used as the third system. In this case, a financial institution terminal is used as the user terminal 40-1, and a terminal of a loan customer company is used as the user terminal 40-2. The financial institution terminal obtains the balance data of a loan customer financial company from the budget control system.

In this case, by converting the budget control data of the budget control management system, sales performance data of the sales support system, and financial data of the accounting system into a common format, the data can be managed by one system (common system). In the case where the information linking data is associated with each identifier and a dataset corresponding to the identifier (e.g., the loan customer company number) is generated, the warning information may be transmitted to the user terminal 40-1 (financial institution terminal) when the abnormal data is extracted in the sales performance data (more specifically, the order/sales data). As a result, the financial institutions can acquire the latest information including the financial-related abnormal data in addition to the normal balance data. As a result, the financial institutions can improve the efficiency of management of the loan customer company and speed up performance judgment.

### Third Embodiment

In the present embodiment, an information linking system and an information linking method different from those of the first embodiment and the second embodiment will be described in detail with reference to the drawings. Configurations similar to those of the first embodiment and the second embodiment will be appropriately omitted and explained.

### (3-1. Configuration of Information Linkage Control Unit 100B)

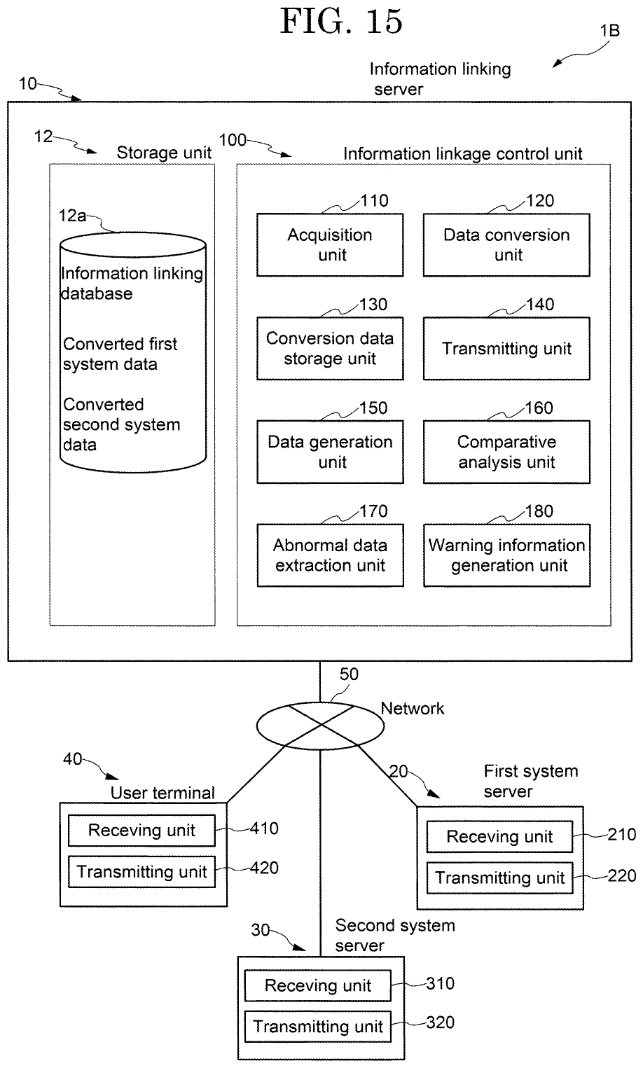

FIG. 15 is a functional block diagram composed of each component of an information linking system 1B.

An information linking server 10B has an information linkage control unit 100B that controls a program (information linking program) that realizes the information linkage function. The information linkage control unit 100 includes an acquisition unit 110B, a data conversion unit 120B, the conversion data storage unit 130, the transmitting unit 140, a data generation unit 150B, the comparative analysis unit 160, the abnormal data extraction unit 170, and the warning information generation unit 180. Each of the acquisition unit 110B, the data conversion unit 120B, the conversion data storage unit 130, the transmitting unit 140, the data generation unit 150B, the comparative analysis unit 160, the abnormal data extraction unit 170, and the warning information generation unit 180 in the information linking server 10B may be executed as a FaaS.

The acquisition unit 110B has a function of acquiring various data in the information linking system. In this example, the acquisition unit 110B acquires the first system data transmitted from the transmitting unit 220 of the first system server 20 and the second system data transmitted from the transmitting unit 320 of the second system server 30.

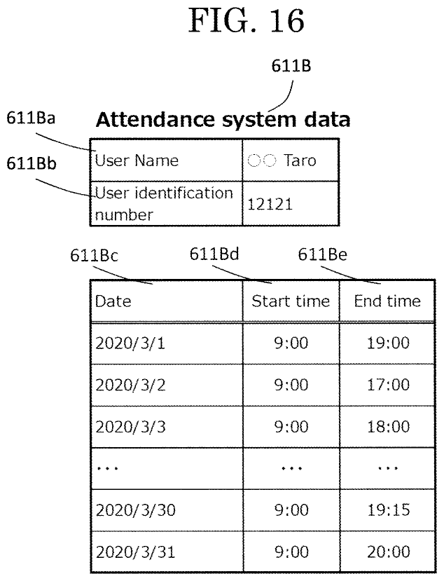

FIG. 16 is an example of a data structure of the first system data. In the present embodiment, an attendance dataset 611B in the attendance system is formed as the first system data. The attendance dataset 611B includes a username 611Ba, a user identification number 611Bb, a date 611Bc, a start time 611Bd, and an end time 611Be. In the attendance system, the username 611Ba and the user identification number 611Bb can be referred to as the first identifier. Attendance data 611B is associated with the username 611a (the user identification number 611b). In the attendance system, each data has a set data format (first data format).

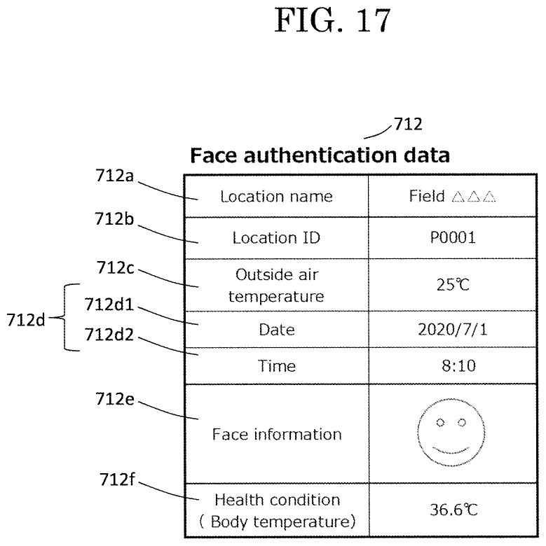

FIG. 17 is an example of a data structure of the second system data. In the present embodiment, a face authentication dataset 712 in the face authentication system is formed as the second system data. The face authentication dataset 712 includes a location name 712a, a location ID 712b, an outside air temperature 712c, a time information 712d (date 712d1, time 712d2), a face information 712e, and a health condition 712f (in this example, body temperature). The face information 712e includes an image captured by an imaging device. In the face authentication dataset 712, the face information 712e is also referred to as first sub-data. The outside air temperature 712c and the body temperature 712f are also referred to as second sub-data. The location name 712a (the location ID 712b) is also referred to as a second identifier. The time information 712d is also referred to as a third identifier. The outside air temperature 712c and the health condition (the body temperature 712f) are also referred to as variation data. Specifically, the outside air temperature 712c is also referred to as second variation data. The health condition (the body temperature 712f) is also referred to as first variation data. It can be said that the face authentication data is associated with the location name (location ID) or the time (date/time). In the face authentication system, each data has a set data format (second data format).

The data conversion unit 120B collates the face information stored in the database with the captured face information and identifies the target user. As a result, the data conversion unit 120B converts the captured face information into the identified username (user identification number). Thus, the data of the face authentication system is associated with the username (or the user identification number).

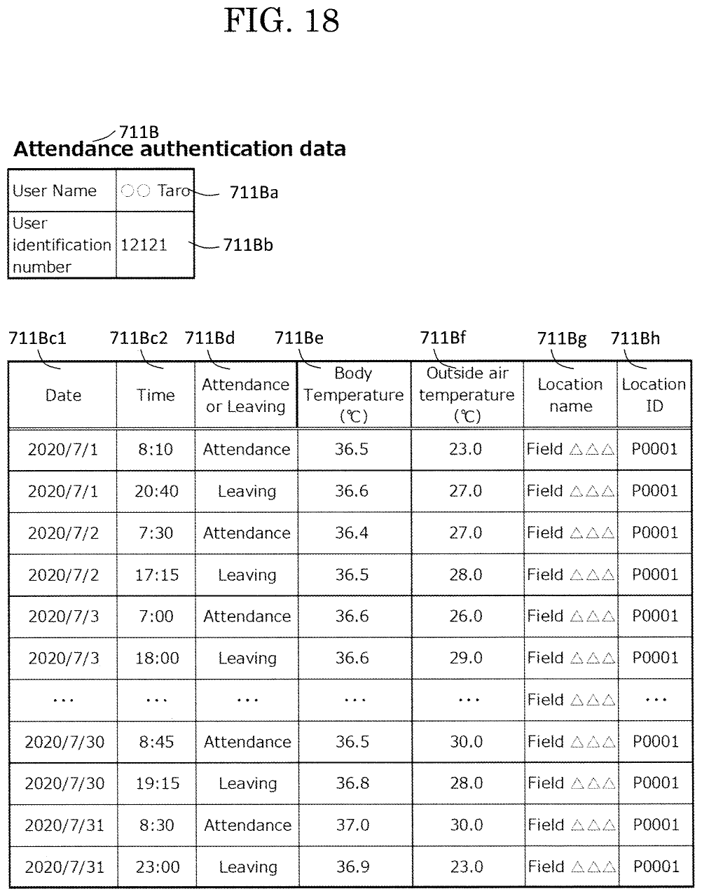

In this case, in the face authentication system, the attendance time and the leaving time of the user are authenticated based on the identified username (user identification number) and time information. FIG. 18 is an attendance authorization dataset 711B. The attendance authentication data 711B includes a username 711Ba, a user identification number 711Bb, a time 711Bc (date 711Bc1, time 711Bc2), an attendance 711Bd, a body temperature 711Be, an outside air temperature 711Bf, a location name 711Bg, and a location ID 711Bh. In this example, although the attendance authorization dataset 711B has data for July 2020, it may include data for each date.

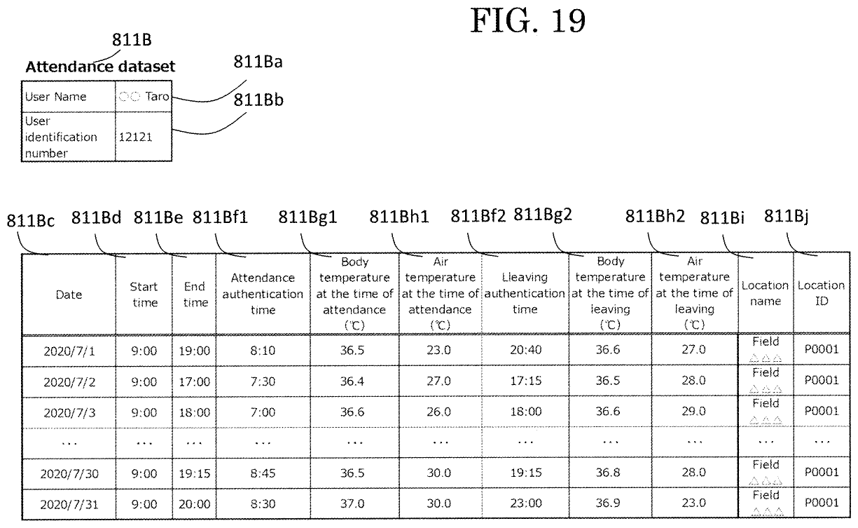

The data conversion unit 120B has a function of converting the first system data and the second system data into a common data format. In this example, the data conversion unit 120B converts the first system data and the second system data into CSV format. Thus, the conversion data storage unit 130 can store the first system data and the second system data in the database as one set of data (attendance dataset). FIG. 19 is an attendance dataset 811B. The attendance dataset 811B includes a username 811Ba, a user identification number 811Bb, a date 811Bc, a start time 811Bd, an end time 811Be, an attendance time 811Bf1, a body temperature 811Bg1 at the time of attendance, an outside air temperature 811Bh1 at the time of attendance, a leaving time 811Bf2, a body temperature 811Bg2 at the time of leaving, an outside air temperature 811Bh2 at the time of leaving, a workplace name 811Bi, and a workplace ID 811Bj. The first system data and the second system data need not necessarily be one dataset. The outside air temperature may be the highest temperature of the day.

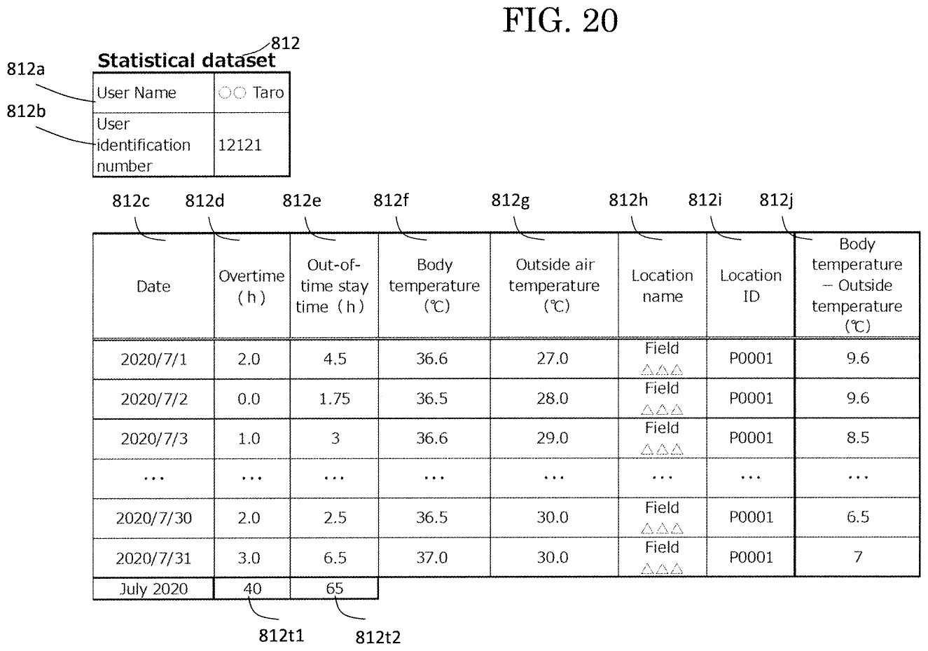

The data generation unit 150B associates the first system data and the second system data with each identifier to generate statistical data. FIG. 20 shows a statistical dataset. A statistical dataset 812 includes a username 812a, a user identification number 812b, a date 812c, an overtime 811Bd, an out-of-time stay time 811Be, a user's body temperature 812f, an outside air temperature 812g, a location name 812h, and a location ID 812i. In this example, the data generation unit 150B statistically processes the attendance data in association with the username (identification number of the user) to generate first statistical data. Specifically, the data generation unit 150B generates total overtime data per month 812t1 as the first statistical data by adding the overtime. The data generation unit 150B statistically processes the second sub-data (attendance time) among the face authentication system data in association with the username (identification number of the user) to generate second statistical data. Specifically, the data generation unit 150B subtracts the attendance time from the leaving time to generate an out-of-time stay time per day 812e and adds the stay time per day to generate a total stay time per month 812t2. Further, as shown in FIG. 20, the data generation unit 150B may generate difference data 812j obtained by subtracting the body temperature and the outside air temperature.

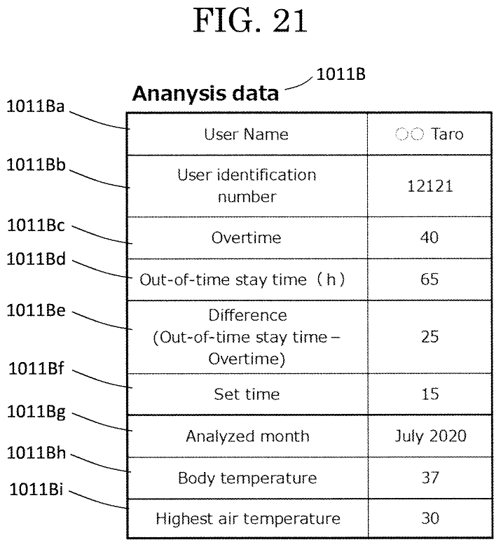

The data generation unit 150B generates analysis data. FIG. 21 is an example of a data structure of analysis data 1011B. The analysis data 1011B includes a username 1011Ba, a user identification number 1011Bb, a total overtime time 1011Bc, a total out-of-time stay time 1011Bd, difference data 1011Be, a set time 1011Bf, a month 1011Bh for performing the analysis, a body temperature 1011Bh, and a temperature 1011Bi. In the present embodiment, the data generation unit 150B may generate the analysis data when the body temperature of the user or the highest temperature in the month in which the analysis is performed satisfies a predetermined condition. For example, analysis data may be generated in the case where the body temperature exceeds 37° C. (when there is a day when it exceeds this temperature) or in the case where the highest temperature is 30° C. or more. The difference data 1011Be is generated by subtracting the total overtime from the total out-of-time stay time. The set time 1011Bf may be arbitrarily set in advance.

(3-2. Information linkage control processing)

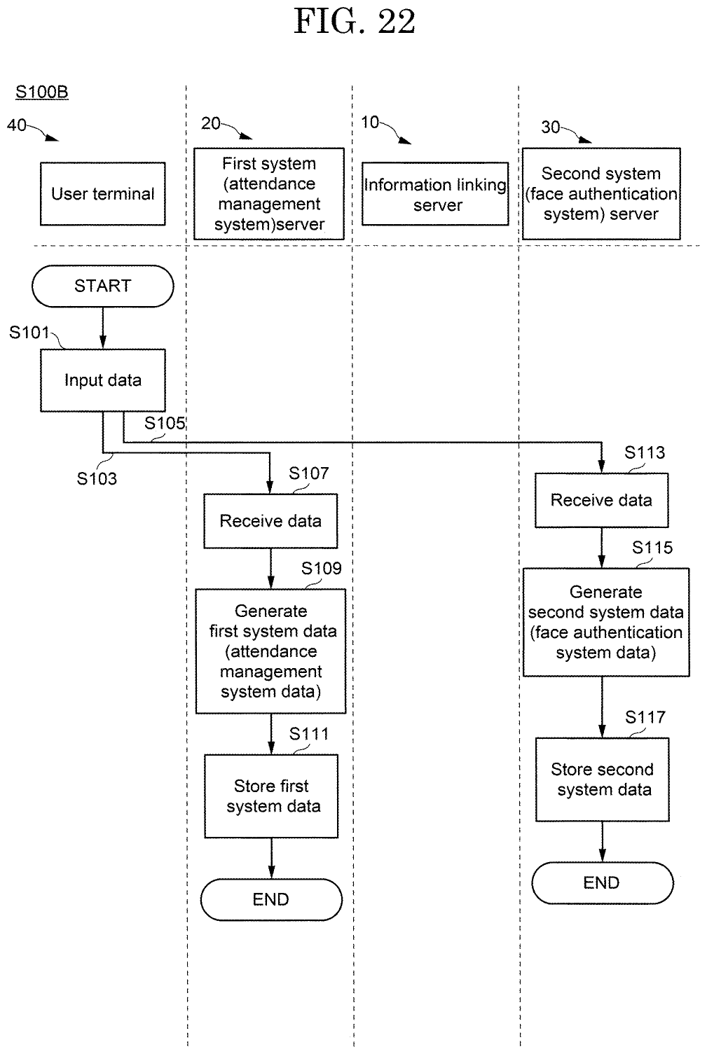

Next, information linkage control processing based on instructions by the information linking program in the information linkage control 100B will be described. FIG. 22 to FIG. 24 are flow diagrams of the information linkage control processing. As shown in FIG. 22 to FIG. 24, the information linkage control processing includes first information linkage control processing S100B, second information linkage control processing S200B, and third information linkage control processing S300B.

### (3-2-1. First Information Linkage Control Processing)

As shown in FIG. 22, first, data is input to the first system (attendance management system) and the second system (face authentication system) by the user terminal 40 (S101B). Specifically, the user of the user terminal 40-1 (the field supervisor of the main contractor, the employee of the management department of the cooperating company, or the field worker) among the user terminal 40 inputs data (attendance work data) to the first system, and the user of the user terminal 40-2 (the field worker) inputs data (face authentication data) to the second system. The user terminal 40-2 in this case may be fixed to the work field. Each input data is transmitted to the first system server and the second system server (S103B, S105B).

When the first system server 20 receives the data input by the user terminal 40-1 (S107B), the first system server 20 executes data processing. Thus, the first system data is generated (S109B). The generated first system data is stored in the storage unit 22 of the first system server 20 (S111B). In this case, as shown in FIG. 3, attendance system data is generated. Specifically, in the attendance system, the start time 611d and the end time 611e of the user are registered by the input from the user registered in the attendance system to the user terminal 40. Further, the overtime 611f is calculated based on the registered start time 611d and the end time 611e. As a result, the first system data in the first data format conforming to the standard of the first system can be memorized and stored.

When the second system server 30 receives the data input by the user terminal 40-2 (S113B), the second system server 30 executes data processing (S115B). Thus, the second system data is generated. The generated second system data is stored in the storage unit 32 of the second system server 30 (S117B). In this example, face authentication system data is generated as shown in FIG. 17. Specifically, in the face authentication system, when the user holds their face over the user terminal 40-2, the face data of the user is input (captured) by the solid-state image sensor mounted on the user terminal 40. In this case, location information, time (date, time), outside air temperature, and user's health information (e.g., body temperature) are input to the face authentication system together with the face information. The data processing may be repeatedly executed a plurality of times. As a result, a plurality of second system data conforming to the standard of the first system can be memorized and stored. As a result, the first information linkage control processing S100B is completed.

### (3-2-2. Second Information Linkage Control Processing)

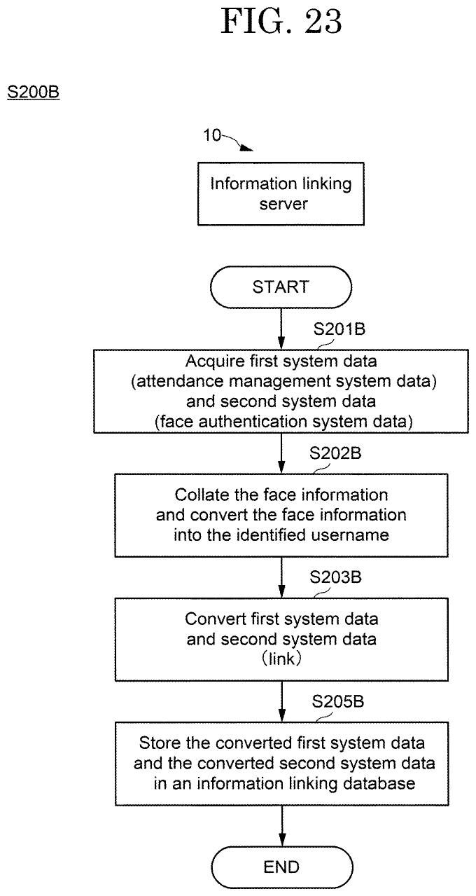

The second information linkage control processing S200B starts with the completion of the first information linkage control processing S100B as a trigger. As shown in FIG. 23, the acquisition unit 110 of the information linking server 10 acquires the first system data transmitted from the transmitting unit 220 of the first system server 20 and then acquires the second system data transmitted from the transmitting unit 320 of the second system server 30 (S201B).

The data conversion unit 120B collates the face information of the user with the captured face information among the second system data (face authentication system data) stored in the database and identifies the target user. In this case, the data conversion unit 120B converts the face information into the identified username (user identification number) (S202B). Thus, the face authentication system data (attendance authentication data) related to the identified user is generated as shown in FIG. 18. In this case, the user's attendance time and leaving time are input using the time 712c and the attendance time 712d, and the user's health information at the time of attendance or leaving is detected.

The data conversion unit 120 executes conversion processing of the data format such that the acquired first system data and the second system data have a common data format (S203B). The data conversion unit 120 converts the first system data and the second system data into CSV format.

Next, the conversion data storage unit 130 stores the converted first system data and second system data in the information linking database 12a (web database) (S205B). In this case, the system data of the two standards (formats) can be stored in one system (also referred to as a common system) as one standard. As a result, the second information linkage control processing S200B is completed.

### (3-2-3. Third Information Linkage Control Processing)

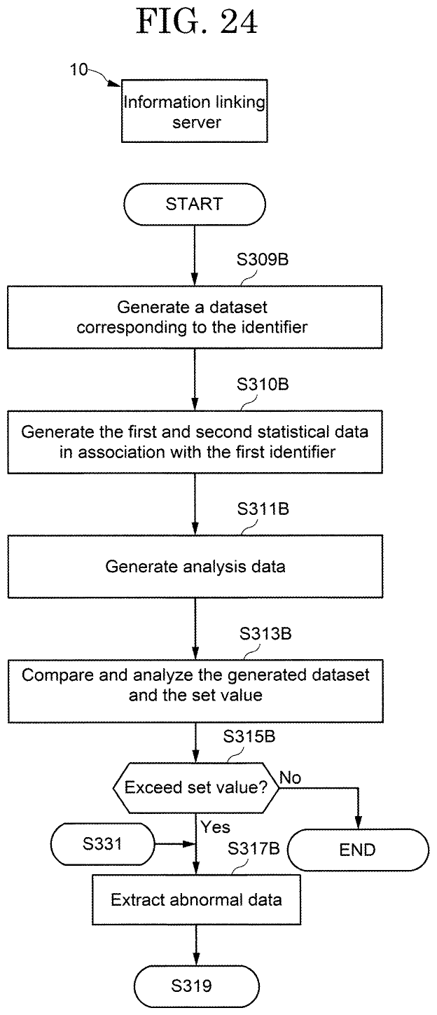

The third information linkage control processing S300B starts with the completion of the second information linkage control processing S200B as a trigger. As shown in FIG. 24, the data generation unit 150B generates each converted system data in association with the identifiers (S309B). In this case, as shown in FIG. 19, the data generation unit 150B generates the attendance dataset 811B using the username (user identification number) and the date as the identifier.

Further, the data generation unit 150B statistically processes the first system data and the second system data in association with the first identifier to generate statistical data as shown in FIG. 20 (S310B). Specifically, the data generation unit 150B may calculate the user's daily overtime by processing the end time, the start time, and a predetermined working time as numerical data among the converted attendance data. The data generation unit 150B may calculate (add) the calculated overtime data to calculate the total overtime data in July 2020 associated with the username (user identification number).

Similarly, the data generation unit 150B calculates the user's daily out-of-time stay time by processing the user's attendance time, the leaving time, and the predetermined working time as numerical data among the converted face authentication system data. The generation unit 150B calculates (adds) the calculated out-of-time stay time data to calculate the total out-of-time stay time data in July 2020 associated with the username (user identification number).

The data generation unit 150B may generate analysis data by statistically processing the first statistical data and the second statistical data when the health condition of the user satisfies a predetermined condition (S311B). Specifically, the user's overtime data and the actual attendance authentication data are calculated, and the difference in the out-of-time stay time may be calculated, as shown in FIG. 21. For example, when the body temperature of the user exceeds the set value (37° C.), the above calculation processing may be performed on the assumption that the user is tired. As a result, it is possible to grasp the labor situation at a timing that could not be judged conventionally.

Next, the comparative analysis unit 160 compares and analyzes the generated dataset and the set value which is set to a predetermined condition (S313B). In this case, a set time of 15 hours or less is set as the predetermined condition. In the case where the difference does not exceed the set time (S315B; No), the third information linkage control processing S300B is completed. In the case where the difference exceeds (deviates from) the set time (S315B; Yes), the data is judged as abnormal data. In FIG. 21, since the difference exceeds the set value, it is determined that the user's July 2020 attendance data is abnormal data. The abnormal data extraction unit 170 extracts abnormal data (S317). The subsequent processing is the same as that of the first embodiment.

As described above, systems can be easily and quickly linked by using the present embodiment. By using the present embodiment, the attendance information of the user can be grasped in detail, and attendance management can be performed in association with the health information.

In the present embodiment, an example in which the location name is used as the second identifier in the face authentication system is shown. However, the present invention is not limited thereto. For example, GPS information or map information may also be used. The second identifier in the second system may include environmental information.

In the present embodiment, although an example in which a health condition (body temperature) is acquired is shown, the present invention is not limited thereto. For example, blood pressure information or heart rate may also be used.

In the present embodiment, an example in which the analysis data is generated based on the health condition is shown. However, the present invention is not limited thereto. For example, the analysis data may be generated when the environmental information (outside air temperature) satisfies a predetermined condition (when the environmental data exceeds the set value). For example, the analysis data may be generated when the outside air temperature is 30° C. or more. This makes it possible to judge whether the user's labor situation is appropriate in response to changes in the environment. The analysis data may be generated when each of the user's body temperature and the outside air temperature satisfies the set value. As a result, attendance management can be performed according to a complex variable factor such as the user's physical condition and environment.

In the present embodiment, an example in which the data conversion unit 120B performs calculation processing for converting the first system data and the second system data into a common data format after the face information is converted into a username (user identification number) is shown. However, the present invention is not limited thereto. The data conversion unit 120B may convert the face information into the username (user identification number) after the conversion processing into the common data format while only the face information is retained at the stage of the conversion processing into the common data format.

The data conversion unit 120B does not need to convert all the data of the first system data and the second system data into one data format (CSV format). For example, the numerical data may be CSV format, and the image data may be converted according to the data format, such as JPEG format. As a result, it is possible to link a plurality of system data more effectively.

In the case where the difference between the body temperature (or average body temperature) and the outside air temperature satisfies a predetermined condition, overtime (or total overtime), out-of-time stay time (or total out-of-time stay time), and the difference between the out-of-time stay time and the overtime may be assessed, respectively. For example, there is a case where the difference between the body temperature and the outside air temperature is 7° C. or less or 37° C. or more as a predetermined condition. Specifically, a summer day or a mid-winter day is assumed. In the case of these conditions, fatigue or the burden on workers may be higher than usual. Therefore, more thorough labor-management (reduction of overtime and stay time) of workers is required. Therefore, by using the present embodiment, it is possible to perform more appropriate labor management in consideration of not only the health condition of the individual user but also the influence of the work environment.

The set time may be changed based on the outside air temperature. Therefore, the set time may be shortened when the outside air temperature is high or low. This makes it easier to grasp abnormalities in working conditions in severe environments. As a result, more appropriate labor management can be performed in consideration of the influence of the work environment, and good health conditions of the worker can be maintained.

In the present embodiment, an example of generating monthly analysis data is shown. However, the present invention is not limited thereto. For example, out-of-time stay time and overtime of the previous day, and the difference data (analysis data) thereof may be generated when the body temperature and the temperature are higher than the set value. As a result, it is possible to judge the real-time health condition and the labor situation of the worker in association with each other.

In the present embodiment, the user may input additional information into the user terminal 40-2. For example, a field supervisor may perform a patrol check of field workers and input labor situation data into the attendance system. For example, the labor situation may be input in three stages: good “1” to bad “3”. The labor situation data can be converted into a common data format. In the case where bad “3” is acquired as the labor situation, the analysis data may be generated. As a result, it is possible to judge the supervisory status of workers by the field supervisor and the real-time health condition and the labor situation of the worker in association with each other.

Although an example in which the face information captured in the present embodiment is used for the authentication of the worker is shown, the face information may be used for estimating the degree of fatigue of the worker. The degree of fatigue may be determined based on preset information such as the color of the face, the swelling of the eyelids, the degree of slack of the cheeks, and the like. The degree of fatigue may be calculated as numerical information in three stages: good “1” to bad “3”. The degree of fatigue can be converted into a common data format. In the case where bad “3” is acquired as the degree of fatigue, the analysis data may be generated. As a result, it is possible to judge the real-time health condition and the labor situation of the worker in association with each other.

In the present embodiment, the statistical data may be used as the analysis data.

(Modifications) Within the spirit of the present invention, it is understood that various changes and modifications can be made by those skilled in the art and that these changes and modifications also fall within the scope of the present invention. For example, the addition, deletion, or design change of components as appropriate by those skilled in the art based on each embodiment are also included in the scope of the present invention as long as they are provided with the gist of the present invention.

In the first embodiment of the present invention, an example in which the information linking server 10, the first system server 20, and the second system server 30 are provided as separate cloud servers is shown. However, the present invention is not limited thereto. For example, two cloud servers of the information linking server 10, the first system server 20, and the second system server 30 may be combined, or three cloud servers may be integrated. The information linking server 10, the first system server 20, and the second system server 30 are not limited to cloud servers, and may be web servers, virtual servers, or physical servers.

In the first embodiment of the present invention, an example in which the information linking server 10, the first system server 20, and the second system server 30 are composed of a plurality of information processing devices is shown. However, the present invention is not limited thereto. The information linking server 10, the first system server 20, and the second system server 30 may be composed of one information processing device. In this case, the server of each system may be provided independently.

In the first embodiment of the present invention, an example in which the data conversion unit 120 converts the first system data and the second system data into the CSV format is shown. However, the present invention is not limited thereto. For example, the data conversion unit 120 may convert the first system data and the second system data into a Java format or may convert them into a common format.

In the first embodiment of the present invention, an example in which the first system data and the second system data are converted and then stored in the information linking database is shown. However, the present invention is not limited thereto. For example, the first system data and the second system data may be acquired and then stored in the information linking database 12a.

In the first embodiment of the present invention, an example in which additional data (third system data) is transmitted from the user terminal 40 (the user terminal 40-1) to the converted first system data and second system data (information linking data), and the information linking server 10 acquires the additional data is shown. However, the present invention is not limited thereto. Further, when the information linking server 10 acquires the additional data, the information linking server 10 may include a data reconversion unit that reconverts the additional data into the first system data (attendance management data) of the first system (for example, the attendance management system) for transmitting to the user terminal 40-2 (the second user terminal) different from the user terminal 40-1.

In the first embodiment, an example in which the transmitting unit 220 of the first system server 20 transmits the first system data after a lapse of a predetermined time is shown. However, the present invention is not limited thereto. For example, the second system data may be transmitted when reaching a certain amount of data. Alternatively, it may be transmitted when receiving transmission instruction information from the information linking server 10.

Similarly, although an example in which the transmitting unit 320 of the second system server 30 transmits the second system data after a lapse of a predetermined time is shown, the present invention is not limited thereto. For example, the second system data may be transmitted when reaching a certain amount of data. Alternatively, it may be transmitted when receiving the transmission instruction information from the information linking server 10.

In the first embodiment of the present invention, an example in which the information linking server 10 receives the first system data and the second system data is shown. However, the present invention is not limited thereto. For example, in the case where the information linking server 10 and the first system server 20 or the second system server 30 are integrated, the acquisition unit 110 may quickly acquire the first system data or the second system data by direct acquisition.

What is claimed is:

1. An information coordinating system comprising:
a processor; and
a memory device configured to store a program, the program being executed by the processor to cause the processor to:
acquire first system data transmitted from a first system server and second system data transmitted from a second system server, the first system data including a first identifier and a first data format associated with a first identifier, and the second system data including a second identifier, first sub-data and second sub-data, the second identifier being different from the first identifier, and the first sub-data and the second sub-data having a second data format associated with the second identifier,
convert the first sub-data of the second system data to the first identifier, and convert the first data format of the first system data and the second data format of the second system data to a common data format, and
generate first statistical data by statistically processing the first system data and generate second statistical data by statistically processing the second sub-data of the second system data associated with the first identifier.

2. The information linking system according to claim 1, wherein
the program further causes the processor to generate analysis data by statistic processing using the first statistical data and the second statistical data when first variation data included in the second sub-data and associated with the first identifier satisfies a predetermined condition.

3. The information linking system according to claim 2, wherein
the program causes the processor to generate analysis data by statistic processing using the first statistical data and the second statistical data when second variation data included in the second sub-data and associated with the second identifier satisfies a predetermined condition.

4. The information linking system according to claim 3, wherein
the first identifier is an identifier related to a user, and
the second identifier is an identifier related to an environment.

5. The information linking system according to claim 4, wherein
the first variation data includes a body temperature of the user,
the second variation data includes a temperature of the environment, and
the predetermined condition is that at least one of the body temperature of the user and the temperature of the environment exceeds a corresponding set value.

6. The information linking system according to claim 5, wherein
the first statistical data and the second statistical data are numerical data, and
the analysis data is the difference between the first statistical data and the second statistical data.

7. The information linking system according to claim 2, wherein
the program causes the processor to
compare the analysis data with a predetermined set value, and
extract abnormal data deviating from the set value among the analysis data.

8. The information linking system according to claim 7, wherein
the program causes the processor to
generate warning information to inform a user terminal of the existence of the abnormal data based on the extracted abnormal data; and
transmit the warning information to the user terminal.

9. The information linking system according to claim 1, wherein
the program causes the processor to convert the first data format of the first system data and the second data format of the second system data into CSV format.

10. An information linking method comprising:
acquiring first system data transmitted from a first system server and second system data transmitted from a second system server, the first system data including a first identifier and a first data format associated with a first identifier, and the second system data including a second identifier, first sub-data and second sub-data, the second identifier being different from the first identifier, and the first sub-data and the second sub-data having a second data format associated with the second identifier,
converting the first sub-data of the second system data to the first identifier, and converting the first data format of the first system data and the second data format of the second system data to a common data format, and
generating first statistical data by statistically processing the first system data and generating second statistical data by statistically processing the second sub-data of the second system data associated with the first identifier.

11. The information linking method according to claim 10, further comprising:
generating analysis data by statistic processing using the first statistical data and the second statistical data when first variation data included in the second sub-data and associated with the first identifier satisfies a predetermined condition.

12. The information linking method according to claim 11, further comprising:
generating analysis data by statistic processing using the first statistical data and the second statistical data when second variation data included in the second sub-data and associated with the second identifier satisfies a predetermined condition.

13. The information linking method according to claim 12, wherein
the first identifier is an identifier related to a user, and
the second identifier is an identifier related to an environment.

14. The information linking method according to claim 13, wherein
the first variation data includes a body temperature of the user,
the second variation data includes a temperature of the environment, and
the predetermined condition is that at least one of the body temperature of the user and the temperature of the environment exceeds a corresponding set value.

15. The information linking method according to claim 14, wherein
the first statistical data and the second statistical data are numerical data, and
the analysis data is the difference between the first statistical data and the second statistical data.

16. The information linking method according to claim 15, further comprising:
comparing the analysis data with a predetermined set value, and
extracting abnormal data deviating from the set value among the analysis data.

17. The information linking method according to claim 16, further comprising:
generating warning information to inform a user terminal of the existence of the abnormal data based on the extracted abnormal data; and
transmitting the warning information to the user terminal.

18. The information linking method according to claim 11, wherein
the first data format of the first system data and the second data format of the second system data are converted into CSV format.

19. A non-transitory computer readable storage medium storing a program for causing a computer to:
acquire first system data transmitted from a first system server and second system data transmitted from a second system server, the first system data including a first identifier and a first data format associated with a first identifier, and the second system data including a second identifier the first identifier and first sub-data and second sub-data, the second identifier being different from the first identifier, and the first sub-data and the second sub-data having a second data format associated with the second identifier,
convert the first sub-data of the second system data to the first identifier, and convert the first data format of the first system data and the second data format of the second system data to a common data format,
generate first statistical data by statistically processing the first system data and generate second statistical data by statistically processing the second sub-data of the second system data associated with the first identifier, and
generate analysis data by statistic processing using the first statistical data and the second statistical data when first variation data included in the second sub-data and associated with the first identifier satisfies a predetermined condition, wherein
the first statistical data and the second statistical data are numerical data, and
the analysis data is the difference between the first statistical data and the second statistical data.
